(19) United States
(12) Patent Application Publication
(10) Pub. No.: US 2006/0043644 A1
(43) Pub. Date: Mar. 2, 2006

(54) Composite ceramic having nano-scale grain dimensions and method for manufacturing same

(76) Inventors: Zwi H. Kalman, Rishon le Zion (IL); Bernard H. Kear, Whitehouse Station, NJ (US); William E. Mayo, Allentown, NJ (US); Ganesh Skandan, Piscataway, NJ (US)

Correspondence Address: Kenneth Watov;Watov & Kipnes, P.C., P.O. Box 247, Princeton Junction, NJ, 08550, US

(21) Appl. No.: 11/259,299

(22) Filed: Oct. 26, 2005

Related U.S. Application Data
(62) Division of application No. 10/049,709, filed on Jul. 16, 2002.
(60) Provisional application No. 60/149,539, filed on Aug. 18, 1999.

(51) Int. Cl. C04B 35/653

(52) U.S. Cl. 264/332

(57) ABSTRACT

A composite ceramic including a first phase of ceramic material and a second phase of ceramic material, the first and second phases forming three dimensional interconnected networks of each phase and having a nano-scaled grain size. The composite ceramic is produced in a method which utilizes rapid solidification at cooling rates of at least ˜10⁴° K./sec to produce a metastable material formed by a solid solution of a two immiscible ceramic material phases, and which also utilizes relatively high pressure/low temperature consolidation to complete densification of the metastable material, while simultaneously generating a composite structure with nano-scale grain dimensions through a controlled phase transformation.

### RELATED U.S. APPLICATIONS

This Application claims foreign priority benefits under 35 U.S.C. 365(a) of PCT International Application No. PCT/US00/22811, filed on Aug. 18, 2000, published in English, and benefits under 35 U.S.C. 119(e) of U.S. Provisional Application No. 60/149,539 filed Aug. 18, 1999.

This Application is a Divisional Application from application Ser. No. 10/049,709, entitled “Composite Ceramic Having Nano-Scale Grain Dimensions And Method For Manufacturing Same” filed on Jul. 16, 2002.

### FIELD OF THE INVENTION

The present invention relates to materials with nano-scale grain dimensions and methods for producing same, and more particularly to a composite ceramic with nano-scale grain dimensions and method for making same which utilizes rapid solidification at cooling rates of ˜10⁶° K./sec to produce a metastable ceramic powder, coating or preform, and which also utilizes relatively high pressure/low temperature consolidation to complete densification of the metastable material, while simultaneously generating the composite structure of the ceramic with nano-scale grain dimensions through a controlled phase transformation.

### BACKGROUND OF THE INVENTION

Rapidly-solidified metallic materials display properties and performance characteristics that are superior to those of their conventionally-cast counterparts. This is because of the marked reduction in dendritic segregation encountered in all systems, and the ability to generate novel metastable crystalline or amorphous phases in many other systems. Thus, rapid solidification processing has become an important new technology for the production of specialty alloys.

Methods for the fabrication of rapidly-solidified metals and alloys include gas or centrifugal atomization of fine powders, melt spinning of thin ribbons, spray forming of bulk materials, and laser melting of surfaces. Today, rapidly solidified metallic powders are being used in the production of heat-resistant superalloys, spray forming is being applied to a wide range of high strength alloys, and melt spinning is being used in the production of both soft and hard magnetic alloys. A few applications have also emerged for laser surface treatments.

Currently, a major thrust of the metal processing industry is to commercialize spray forming technology, primarily because of its versatility, scalability, and cost effectiveness.

The relevant prior art in plasma processing of materials has been concerned primarily with the fabrication of coatings by plasma spraying. In current industrial practice, powders of the material to be sprayed are fed continuously into the hot zone of the plasma. Rapid melting of the particles occurs, followed by rapid quenching on a cold substrate. The large impact forces created as the molten particles arrive at the substrate surface promote strong particle-substrate adhesion and the formation of a dense coating. Typically, standard powder feeds for plasma spraying have particle sizes in the 5-50 micrometer range. Such powders are normally produced by mechanical mixing of the constituent phases in a fluid medium, followed by spray drying to produce an agglomerated powder. In some cases, the agglomerated powder is plasma densified, so as to develop a more robust powder product. Sprayable ceramic powders of a wide range of compositions are available commercially.

One relevant paper in the literature describes the formation of metastable phases by plasma melting and water quenching of Al₂O₃/ZrO₂ powders. The effects of subsequent heat treatments to decompose the metastable powder, which contained an amorphous component, into its equilibrium two-phase structure has also been reported. However, no effort has been made to consolidate the material to limit grain growth during phase decomposition, and therefore achieve a uniform composite structure with nano-scale grain dimensions.

Accordingly, a need exists for a method of producing uniform composite structures with nano-scale dimensions wherein the individual grains have an average grain size of 100 nanometers or less (hereinafter referred to as nano-scale).

### SUMMARY OF THE INVENTION

A method for producing a composite ceramic article having a nano-scaled grain structure, the method comprising the steps of: forming a metastable ceramic material; pressure sintering the material at a temperature ranging between 25% and 60% of the melting point thereof and at a pressure ranging between 1.5 GPa and 8 GPa thereby forming the composite ceramic article having a nano-scale grain structure.

The metastable material formed in the method is a solid solution of a two immiscible phases of ceramic material.

The composite ceramic article made according to the above method comprises a first phase of ceramic material and a second or more phases of ceramic material. When the starting ceramic composition is mixed in ratios ranging between 60:40 and 40:60, the first and second phases of the article form three dimensional interconnected networks, wherein each network contains only one of the phases in a contiguous form.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 shows a block diagram of a method for fabricating composite ceramic articles having nano-scaled grain structures according to the present invention;

FIG. 2A shows the plasma spraying of a metastable ceramic powder onto an inclined water-cooled copper chill to produce inclined impacts;

FIG. 2B shows the plasma spraying of a metastable ceramic powder onto a perpendicular water-cooled copper chill to produce perpendicular impacts;

FIG. 3A shows a field emission scanning electron microscope (FESEM) micrograph of Al₂O₃/13 weight percent TiO₂ powder plasma sprayed into water with a cooling rate of ˜10⁴° K./sec;

FIG. 3B shows a FESEM micrograph of Al₂O₃/13 weight percent TiO₂ powder plasma sprayed onto a water cooled inclined copper chill plate with a cooling rate of ˜10⁶° K./sec;

FIG. 4 shows X-ray diffraction patterns depicting the decomposition reactions of Al₂O₃/13% TiO₂ plasma melted and sprayed into water;

FIG. 5 shows an X-ray diffraction pattern of molten Al₂O₃/13% TiO₂ powder splat cooled onto an inclined copper chill plate;

FIG. 6 shows an X-ray diffraction pattern of a splat cooled coating of Al₂O₃/13% TiO₂ plasma sprayed onto a steel substrate and built up to a thick coating by multiple passes; and

FIG. 7 shows an X-ray diffraction pattern of an Al₂O₃/13% TiO₂ starting powder that was plasma melted and quenched directly into water and an X-ray diffraction pattern of powder pressed and sintered by a low temperature, high pressure consolidation process transformation assisted consolidation (TAC) wherein the starting powder was predominantly χ-Al₂O₃.TiO₂ while the sintered product was predominantly α-Al₂O₃.

### DETAILED DESCRIPTION OF THE INVENTION

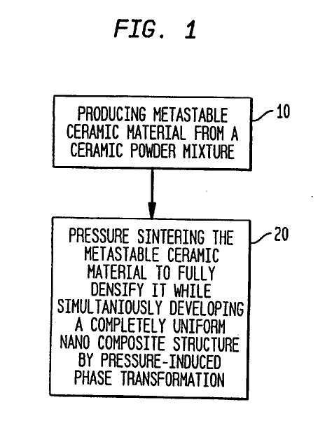

FIG. 1 is a block diagram of a method for fabricating composite ceramic articles having nano-scaled grain structures. The method comprises essentially two steps. In the first step 10 of the method, a metastable crystalline or amorphous phase material comprised of a solid solution of two immiscible ceramic phases is produced by conventionally mixing two single phase ceramic powders in the range of 0 to 100 volume percent for each phase and then treating the mixture in a plasma melting and quenching process. The ceramic powders can include, for example, Al₂O₃ and TiO₂, although other ceramic systems such as nitrides, carbides, silicon aluminum oxygen nitrogen (SiAlON) and mixtures thereof can also be used. During the plasma melting and quenching process, the mixed ceramic powder feed is melted and homogenize in a plasma spray gun and sprayed by the gun into molten particles. The molten particles are then rapidly solidified to produce the metastable crystalline or amorphous material.

In the second step 20 of the method, the metastable material is pressure sintered (hot pressed) to fully densify the material into a composite ceramic article having a nano-scale grain structure. Pressure sintering is preferably accomplished using a transformation assisted consolidation (TAC) process which utilizes high pressures and low temperatures to complete the densification and transformation of the metastable material. The preferred pressure range is between 1.5 GPa and 8 GPa and the preferred temperature range is between 25% and 60% of the melting point of the material. The high pressure/low temperature consolidation process completes densification of the as-quenched metastable material, while simultaneously developing a completely uniform nano-scale composite structure by a pressure-induced phase transformation mechanism.

TAC has proven to be a useful method for consolidating nano-scale powders to produce a fully sintered end product which retains the nano-scale grain size and all the advantages associated with finer microstructures. A key component of the method of the invention is the utilization of the metastable starting material that undergoes a phase transformation during sintering. Since most transformations are a nucleation and growth process, both processes can be controlled by a suitable choice of temperature and pressure. Diffusion rates can be reduced for example, by lowering the temperature and raising the applied pressure. Also, the nucleation rate can be increased by increasing the pressure, and to some extent by lowering the temperature. Lowering the diffusion rate will slow down the kinetics, while increasing the nucleation rate of the stable phase(s) will result in a finer sintered grain size. Thus, a combination of high pressure and low temperature is desired for optimum control.

The method of the present invention can be used to make a wider range of nano-scale composite ceramics than prior art methods which produce metastable starting powders by rapid condensation from the vapor state utilizing Chemical Vapor Condensation (CVC) process. This is because metastable starting powders, produced by the present method's rapid solidification from the liquid state process, can be made from a wide range of ceramic powders, including powder mixtures, that can be plasma melted and splat quenched in accordance with the present invention to generate a metastable crystalline or amorphous material.

Rapid solidification of the molten ceramic powder (in the first step of the method) is preferably accomplished by quenching the same on an inclined water-cooled copper chill plate to develop cooling rates of ˜10⁶° K./sec, so that the resulting “splat-quenched” material displays little or no chemical segregation. The angular range of the inclined chill plate is preferably at least 10 degrees from the normal and the temperature of the plate is preferably less than 150° F. Cooling rates of ˜10⁶° K./sec are preferred because they ensure a homogeneous metastable ceramic product, i.e., a product that has experienced plane-front, segregation-less solidification. It should be understood, however, that cooling rates as low as ˜10⁴° K./sec can also be used in the present invention for rapid solidification, although the quenched material may include some deleterious primary solidification phases. Such cooling rates are typically obtained by spraying in water that is at room temperature. Cooling rates between ˜10⁵° K./sec and ˜10⁶° K./sec can be obtained by spraying onto uncooled steel substrates.

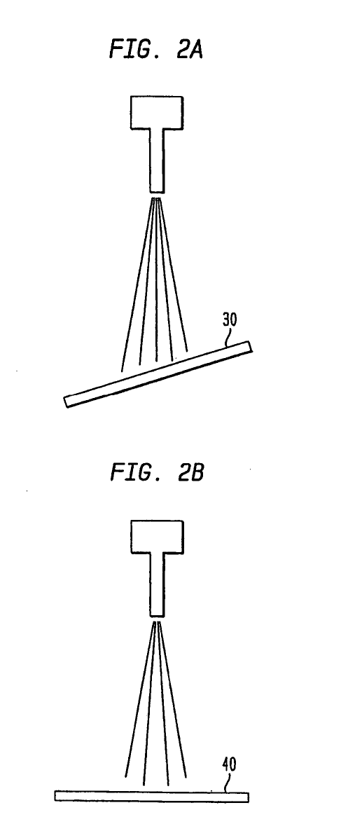

The metastable product can be produced in powder form, as a coating, or as a preform. In a preferred embodiment of the invention, powders of metastable material are produced by spraying the molten droplets of ceramic powder onto an inclined (about 45 degrees from the normal) water-cooled copper chill plate 30 as shown in FIG. 2A to produce inclined impacts, which shear the solidifying droplets into thin splat-quenched particulates. Typically, the splats have aspect ratios as high as 5:1, with a thickness in the range of 2-5 micrometers and produce metastable crystalline or amorphous ceramic powders which are unattainable with prior art methods.

Coatings and preforms of metastable material are produced in a preferred embodiment of the invention by spraying the molten droplets of ceramic powder onto an inclined water-cooled copper chill plate 30 (or a steel substrate) as shown previously in FIG. 2A to produce inclined impacts or onto a perpendicular water-cooled copper chill plate 40 as shown in FIG. 2B to produce perpendicular impacts. Sheets up to about 0.5 inches thick can be made by carefully controlling the temperature of the chill plate to maintain the preferred cooling rate of ˜10⁶° K./sec. This can be accomplished by traversing the particle beam of the plasma spray gun back and forth over the surface of the chill plate, such that the preform is built up incrementally by the superposition of splat-quenched particulates. The resulting metastable sheet material contains a high degree of porosity, because of the nature of the incremental deposition process. However, most of this porosity consists of isolated pores which are easily eliminated by the subsequent pressure sintering step of the method.

When producing preforms, after the coating process is completed, the material is removed from the substrate and then cut into the desired preform shape. As an example, the sheet material can be cut into circular disks of several inches in diameter to feed into a conventional die and anvil. These blanks can then be sintered via the TAC process at a preferred pressure range of between 1.5 GPa and 8 GPa and at a preferred temperature range of between 25% and 60% of the melting point of the material. This approach allows the preliminary step of powder pre-consolidation to be advantageously eliminated, thereby avoiding coarsening of the microstructure that occurs during pressure-less sintering.

Coarse, micron-scale or fine, nano-scale ceramic powders, or mixtures thereof, can be used as feedstock powder for plasma spray processing, with essentially the same result because of the high temperatures in the plasma. Since the melting kinetics are somewhat faster for fine-grain powder, a mixture of coarse-and fine-grain powders can be used to generate a novel bimodal structure, composed of a uniform dispersion of unmelted micron-scale particles in a rapidly solidified nano-scale material composite ceramic matrix. Such bimodal ceramic structures should have property advantages that cannot be realized with unimodal structures.

When the starting ceramic compositions are mixed in ratios corresponding to the range of 60:40 to 40:60 mixtures of two ceramic phases under equilibrium conditions, the resulting sintered products have a bicontinuous, nano-scale grain size composite structure in which both phases form three-dimensional interconnected networks of the two phases wherein each network contains only one of the phases in a contiguous form. Formation of this structure may be preceded by a transient period of unrestricted growth of one or both equilibrium phases, after which the growth rate slows down dramatically, since one phase strongly impedes the growth of the other. The composite structure is further characterized by individual constituents with grain sizes of less than 0.1 microns; a second phase volume fraction which exceeds 5 volume percent; second phase particles homogeneously distributed along grain boundaries of the primary matrix phase so that each grain boundary of the primary phase is decorated by up to 10 second phase particles; and an average spacing between the second phase particles of no more than twice the average grain size of the primary phase. Thus, the properties and performance characteristics of the fully dense nanophase ceramic products are substantially improved, relative to all other known types of fine-ceramic materials.

### EXPERIMENTAL WORK

The following discussion details experimental work pertaining to the cooling rate used in the plasma melting and quenching process of method of the present invention.

Plasma melting and quenching tests were carried out using a standard Metco 3M gun, mixed ceramic powder feeds, and typical processing parameters. Tests were conducted by spraying the plasma-melted and homogenized particles (1) into cold water to produce rapidly solidified spherical particles (cooling rate ˜10⁴ K/sec), (2) onto an inclined copper chill plate to develop splat-quenched particulates (cooling rate ˜10⁶ K/sec), and (3) onto a normal or inclined copper chill plate to form a splat-quenched coating or preform (cooling rate 10⁵-10⁶ K/sec).

### Example #1

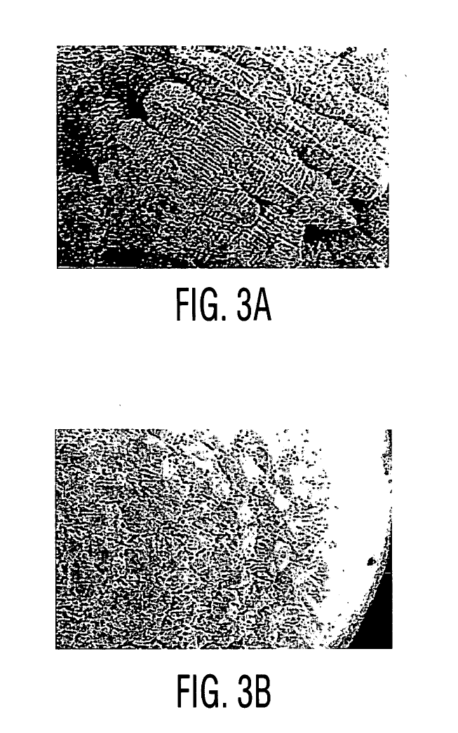

Powder consisting of Al₂O₃ and 13 weight percent TiO₂ was purchased from a commercial source (Metco). This powder had a conventional grain size in the micrometer range and consisted of two distinct phases (Al₂O₃ and TiO₂). These powders were fed into a N₂/10% H₂ plasma spray gun with a protective Argon gas shroud and sprayed into cold water less than 12″ from the gun nozzle. During the short residence time in the plasma jet stream, the powders were completely melted and homogenized. When the liquid droplets hit the water, they solidified in one of two microstructural forms, depending on the cooling rate. When the cooling rate was only moderate (≈10⁴° K./sec), the solidified powders consisted of a dendritic structure and exhibited some phase separation as shown in the FESEM micrograph of FIG. 3A. However, when the cooling rate was higher (≈10⁵° K./sec), the structure consisted of a cellular microstructure as shown in FESEM micrograph of FIG. 3B.

The dendritic and cellular microstructures consisted of an unidentified amorphous phase, primary α-Al₂O₃ (corundum structure) and a metastable phase Al₂O₃.TiO₂ phase which was termed χ phase. Computer simulations of the X-ray diffraction pattern from the χ phase revealed it to be a solid solution of Al₂O₃ and TiO₂, where the Ti atoms randomly occupy Al lattice sites. The crystal structure of this phase was cubic (spinel type with Fd3m space group). Because this phase is metastable, it will decompose upon heating.

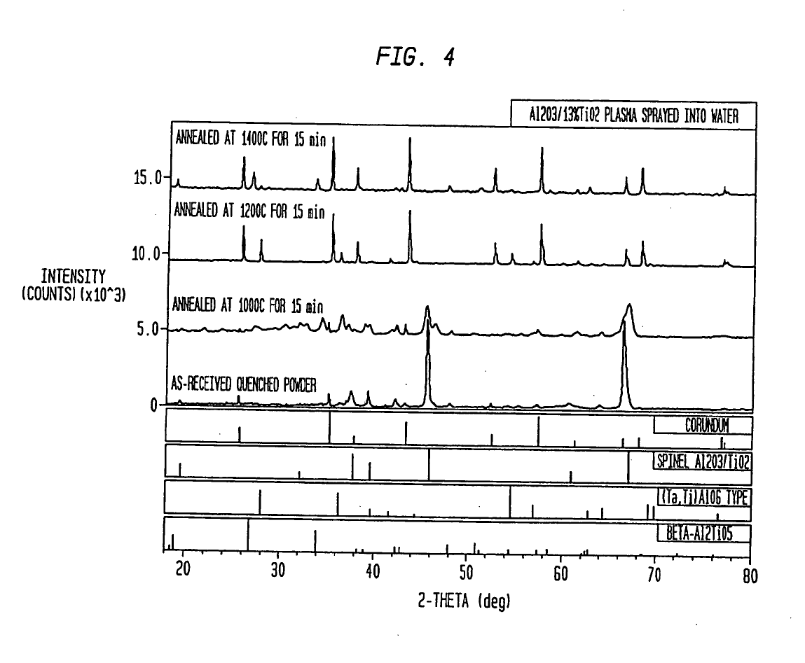

When the χ phase was heated at temperatures below 1200° C. and at atmospheric pressure, the χ phase decomposed into a series of intermediate phases. The first such intermediate phase to appear had an unknown structure, which has no known analogue. Soon thereafter, a tetragonal phase appeared (termed η phase) and is similar to the known (Ta,Ti)Al₂O₆ crystal structure. This η phase is also metastable and decomposes further into the stable α-Al₂O₃ and β-Al₂O₃.TiO₂ (a known orthorhombic structure with Cmcm space group). Thus, the final microstructure consisted of primary micron scale α-Al₂O₃ and secondary nano-scale α-Al₂O₃ that co-precipitated with the β-Al₂O₃.TiO₂. FIG. 4 illustrates these phase transitions through their respective X-ray diffraction patterns.

The key points to note in this example are the metastable nature of the powder in the as-quenched state, and the ability to control the decomposition products through choice of the sintering time and temperature. In all of the samples shown in this example, however, the sintering was done in a pressureless mode. As a result, the grain size of the sintered product could not be controlled and the final products exhibited a grain size with micron dimensions.

### Example #2

In the previous example, the mixed commercial powder (Al₂O₃ and 13w/oTiO₂ purchased from Metco) was plasma melted and sprayed directly into water. While the cooling rate was high, the structure formed was still mostly crystalline, consisting of a mixture of primary α-Al₂O₃ and a metastable phase. In order to produce an amorphous material, higher cooling rates were deemed necessary. This was achieved by spraying the molten powder onto a cooled copper chill plate inclined at an angle with respect to the plasma particle beam direction. The copper material produces cooling rates at least an order of magnitude higher compared to direct water spraying. In addition, the angling of the chill plate is angled with respect to the particle beam direction produced significant shearing of the solidifying splats. Such splats present a larger surface area to the chill plate, which further enhances the solidification rate. The shearing of the splats also helped to break up any agglomerates that formed in the plasma field.

The splats that formed by chilling against the copper plate were generally close to a fully amorphous state and did not exhibit any of the deleterious primary α-Al₂O₃ found in the water quenched materials. It is important to avoid the formation of any stable primary phases such as αAl₂O₃ since these particles tend to be large and coarsen during consolidation. As a result, they represent potential flaws in the fully dense material and may undercut the property enhancements generated by the otherwise nano-scale grain structure.

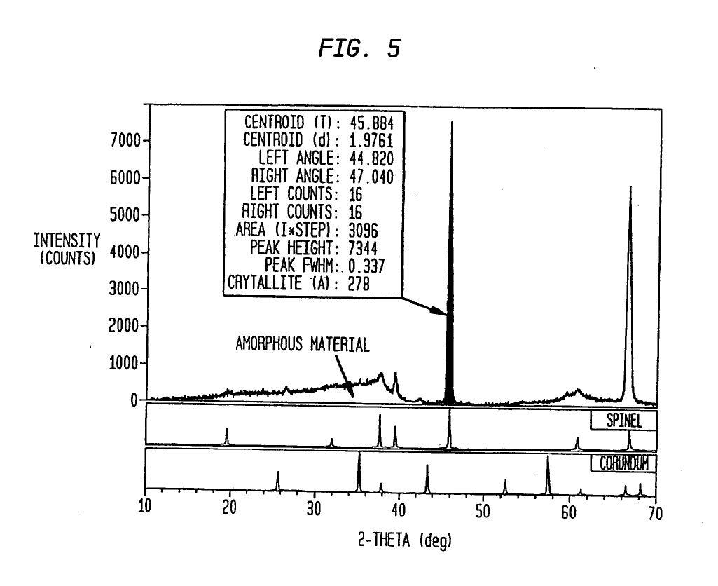

As shown in the x-ray diffraction pattern of FIG. 5, powders splat cooled onto the angled copper plate consisted of only an amorphous phase plus the χ-Al₂O₃.TiO₂ phase with an average particle size of 28 nm. By comparison, powders sprayed directly into water had grain sizes of several microns. Moreover, little or no primary α-Al₂O₃ was detected in splat cooled processed powders.

Referring again to the x-ray diffraction pattern of FIG. 5, several features can be observed which suggest the presence of a strongly disordered structure that is far from equilibrium. First, note the presence of an amorphous phase indicated by the “hump” in the diffraction pattern at 35°. Also, the diffraction peaks are strong only for the spinel peaks at approximately 46° and 66.5°. All the other peaks for this phase have very low intensity. Computer simulations of proposed structures show these observations are explained by a disordered solid solution of Al₂O₃ and TiO₂, with both Al and Ti atoms randomly occupying a portion of the octahedral and tetrahedral lattice sites. Finally, note that the broadening of the diffraction peaks reveals that the particle size of the χ phase is only 28 nm, indicating an extremely rapid solidification rate, consistent with the formation of disordered and amorphous phases.

Since the as-prepared powder contained no primary α-Al₂O₃, the entire structure will undergo decomposition upon further processing such as heating. Consequently, when the equilibrium structure is produced (secondary α-Al₂O₃ and β-Al₂O₃.TiO₂) the resulting structure should consist of homogeneously distributed co-precipitates. This is an extremely important result, since the optimum properties of a two-phase composite (formed by decomposition of the solid solution) would be strongly linked to the homogeneous distribution of the two phases. Thus, by improving the distribution of the phases, we can improve the composite properties such as toughness and strength.

### Example #3

The previous two examples focused on production of a metastable solid solution by quenching molten powder after it had passed through a plasma spray gun. Other forms are also possible. Of great importance is the ability to form the metastable powder into thick coatings that adhere to a substrate. Such coatings may be used in their native form (solid solution), or they may be allowed to decompose into a two phase composite by proper control of the heating and pressure conditions as described in Example #4 described further on.

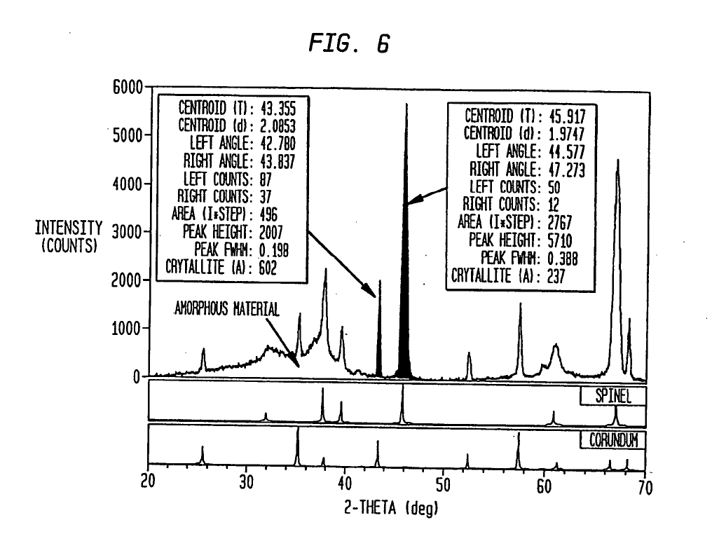

In the present example, commercial ceramic powder (Al₂O₃ and 13w/o TiO₂ purchased from Metco) with micron sized grains was plasma sprayed directly onto a steel substrate, oriented perpendicular to the plasma jet direction. Since the molten droplets were quenched by the steel, a structure similar to that shown in examples #1 and #2 was formed. The thickness of the coating was controlled by moving the plasma gun repeatedly over the substrate, thus building up a thick coating through deposition of multiple layers. Since the quenching rate of the molten droplets against the steel substrate was not as high as that obtained by using the copper chill plate, the extent of amorphitization and suppression of α-Al₂O₃ formation was not as good. Thus, in the x-ray diffraction pattern of FIG. 6, the coating can be seen to consist of the χ-Al₂O₃.TiO₂ phase as the majority phase, an amorphous phase, and the primary α-Al₂O₃ phase. Fortunately, the α-Al₂O₃ phase that formed had a grain size of only 60 nm, which is believed to be small enough to avoid the problems previously cited for primary α-Al₂O₃. Note also in FIG. 6, that many of the minor peaks in the χ-Al₂O₃.TiO₂ phase are more intense than in the diffraction pattern of the more rapidly quenched structure shown in FIG. 5. This likely indicates that the present structure has a lesser degree of disorder, which is consistent with a slower cooling rate.

### Example #4

In Example #3, the melting and quenching procedure was used to produce thick coatings of the metastable ceramic deposited onto a steel substrate. Another useful version of the thick form is the creation of preforms for consolidation and pressureless sintering. As described in Example #5, it has been found that the decomposition of the metastable form can be controlled by sintering the metastable material under very high pressures and low temperature. The high pressure simultaneously slows down the diffusion process and increases the number of nucleation events of the stable phases. Therefore, the TAC process is well suited for sintering the metastable materials described here.

Spraying the plasma melted material onto a copper or steel substrate allowed the build up of a thick layer (about 0.5″) of solid by using multiple passes. After the coating process was completed, the material was removed from the substrate and then cut into the desired preform shape. In this example, the sheet material was cut into circular disks of several inches in diameter and fed into a conventional die and anvil. The blanks were then sintered via the TAC process. The advantage of this approach is that the preliminary step of pre-consolidation of powders is eliminated, thereby avoiding coarsening of the microstructure that occurs during pressureless sintering.

### Example #5

Transformation assisted consolidation (TAC) has proven to be a useful method for consolidating nanopowders to produce a fully sintered end product which retains the nanoscale grain size and all the advantages associated with the finer microstructure. As mentioned previously herein, a key component of the method of the invention is to utilize a metastable starting material that undergoes a phase transformation during sintering. Since most transformations are a nucleation and growth process, it is possible to control both processes by suitable choice of temperature and pressure. Diffusion rates can be reduced for example, by lowering the temperature and raising the applied pressure. Also, the nucleation rate can be increased by increasing the pressure, and to some extent by lowering the temperature. Lowering the diffusion rate will slow down the kinetics, while increasing the nucleation rate of the stable phase(s) will result in a finer sintered grain size. Thus, a combination of high pressure and low temperature is desired for optimum control.

As described earlier, the rapidly quenched χ-Al₂O₃.TiO₂ phase is in a metastable state that would like to decompose. Unfortunately, if the reaction occurs under normal sintering conditions, the transformation is rapid and uncontrollable for commercial applications. The use of the TAC process during sintering, however, makes the transformation substantially easier to control.

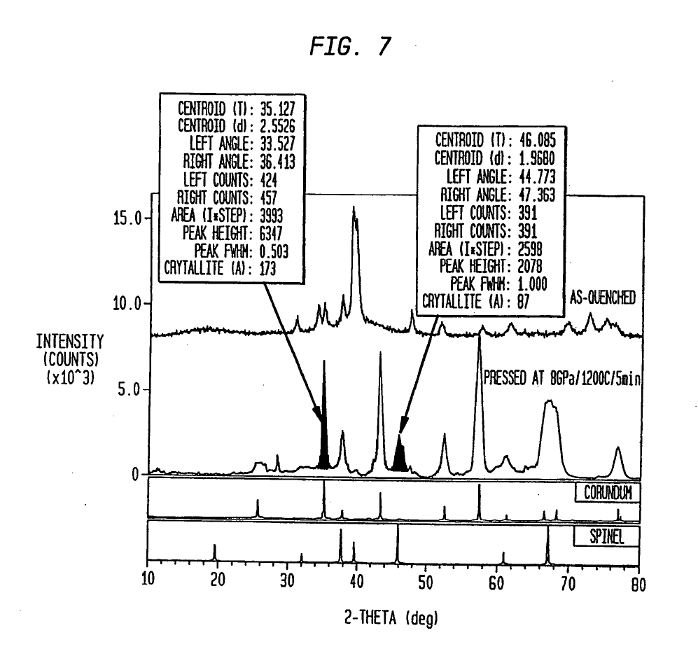

To demonstrate the control that is possible with decomposition of χ-Al₂O₃.TiO₂ via the TAC process, a ceramic powder of Al₂O₃/13% TiO₂ was plasma melted and sprayed into water as described in Example #1. The as-quenched powder was then cold compacted to form a blank and placed into the TAC press at 8 GPa/1200° C. for 5 minutes. As shown in the x-ray diffraction patterns of FIG. 7, the resulting sintered sample consisted of approximately 80% α-Al₂O₃ and 20% χ-Al₂O₃.TiO₂. Note that the α-Al₂O₃ formed by precipitation since the starting powder contained only approximately 5% α-Al₂O₃. A key point to note is that the grain size of the alumina was only 17 nm, while the residual χ-Al₂O₃.TiO₂ phase had an extraordinarily fine grain size of only 9 nm.

As should now be apparent, a homogeneously distributed bi-phasic composite with nano-scale dimensions can be produced using the method of the present invention. The requisite ingredients are a metastable powder such as that produced by the plasma melting and quenching and the ability to control the phase separation via TAC. Both of these ingredients are essential, since one without the other will not provide the necessary control of the structural evolution.

While the foregoing invention has been described with reference to the above embodiments, various modifications and changes can be made without departing from the spirit of the invention. Accordingly, such modifications and changes are considered to be within the scope of the appended claims.

What is claimed is:

1. A method for producing a composite ceramic article having a nano-scaled grain structure, the method comprising the steps of:
forming a metastable ceramic material;
pressure sintering the material at a temperature ranging between 25% and 60% of the melting point of the material and at a pressure ranging between 1.5 GPa and 8.0 GPa thereby forming the composite ceramic article.

2. The method according to claim 1, wherein the metastable ceramic material forming step includes solidifying molten particles of a ceramic powder mixture.

3. The method according to claim 2, wherein the solidifying step includes quenching the molten particles of the ceramic powder mixture at a cooling rate of at least 10⁴° K./sec.

4. The method according to claim 2, wherein the molten particles of the ceramic powder mixture are generated by plasma spraying the ceramic powder mixture.

5. The method according to claim 4, wherein the ceramic powder mixture includes Al₂O₃ and TiO₂.

6. The method according to claim 2, wherein the ceramic powder mixture includes Al₂O₃ and TiO₂.

7. The method according to claim 1, wherein the metastable ceramic material forming step includes spraying molten particles of a ceramic powder mixture against water.

8. The method according to claim 1, wherein the substrate comprises a cooled metallic chill plate.

9. The method according to claim 1, wherein the metastable ceramic material forming step includes mixing a first phase of ceramic material with a second phase of ceramic material, the second phase being at least 5 volume percent of the first phase.

10. The method according to claim 1, wherein the metastable ceramic material forming step includes mixing a first phase of ceramic material with a second phase of ceramic material to form a near eutectic composition.

11. The method according to claim 1, wherein the metastable ceramic material forming step includes mixing a first phase of ceramic material having micron-scale particles with a second phase of ceramic material having nano-scale particles.

12. The method according to claim 1, wherein the metastable ceramic material forming step includes mixing a first phase of ceramic material with a second phase of ceramic material in a ratio ranging between 60:40 and 40:60.

13. The method according to claim 12, wherein the first and second phases of the composite ceramic article form three dimensional interconnected networks of each phase.
